(19) United States
(12) Patent Application Publication
(10) Pub. No.: US 2010/0309691 A1
(43) Pub. Date: Dec. 9, 2010

(54) DC/DC CONVERTER WITH FULLWAVE REGULATION

(75) Inventors: Thierry BAPTISTE, Lannion (FR); Marcel Le Gall, Plestin Les Greves (FR)

Correspondence Address: SUGHRUE MION, PLLC, 2100 PENNSYLVANIA AVENUE, N.W., SUITE 800, WASHINGTON, DC, 20037, US

(73) Assignee: AEG POWER SOLUTIONS B.V., Ah Zwanenburg (NL)

(21) Appl. No.: 12/791,442

(22) Filed: Jun. 1, 2010

(30) Foreign Application Priority Data
Jun. 5, 2009 (FR) 0953764

(51) Int. Cl. H02M 3/335

(52) U.S. Cl. 363/21.06

(57) ABSTRACT

A secondary circuit for a DC/DC converter, the secondary circuit having a main outlet and an auxiliary outlet, the secondary circuit comprising a main automatically controlled synchronous rectifier circuit receiving a voltage from the secondary winding of a transformer having an intermediate tap and delivering firstly a fullwave first rectified voltage for the main outlet and secondly a halfwave second rectified voltage, and an auxiliary synchronous rectifier circuit controlled by a synchronous post regulation control circuit receiving the halfwave second rectified voltage V2 and delivering a halfwave third rectified voltage for the auxiliary outlet.

### TECHNICAL FIELD

The present invention relates to the field of direct-current/direct-current (DC/DC) converters having multiple outlets, and it relates more particularly to a converter secondary circuit having a main outlet and an auxiliary outlet.

### PRIOR ART

DC/DC converters are very widespread in industry and they exist in a variety of topologies, most including a transformer to provide electrical isolation between the inlet and the outlet of the converter. Particularly well-known are the “flyback” and “forward” topologies, for example, that present advantages in particular because of the simplicity with which they can be made and their low cost, but both of them operate with halfwave rectification. There are also fullwave “push pull” and “full bridge” topologies that not only require more components for the primary or the secondary, but that are also often to be excluded because of cost or their size.

Furthermore, it is sometimes desirable for such converters to have a plurality of outlets. Thus, patent EP 1 335 483 A1 has a main outlet associated with an auxiliary outlet that is generated from the rectified signal of the main outlet. In patent WO 2008/006992 A1, the secondary of the isolation transformer has not only the first secondary winding, but also a second secondary winding, and the rectified signal from the main outlet is used for synchronizing the auxiliary outlet.

Nevertheless, those configurations still present the drawback of being relatively complex and not very economical in terms of cost and size.

### OBJECT AND SUMMARY OF THE INVENTION

An object of the present invention is to mitigate the above-mentioned drawbacks by proposing a DC/DC converter with a secondary circuit having a main outlet Vp and an auxiliary outlet Va, wherein the secondary circuit comprises:
an automatically-controlled main synchronous rectifier circuit receiving a secondary voltage from a transformer having an intermediate tap, having a first secondary winding connected in series with a second secondary winding and delivering a fullwave first rectified voltage V1 for said main outlet at said intermediate tap connecting together two of the ends of said first and second secondary windings, and a halfwave second rectified voltage V2 across the terminals at the other two ends of said first and second secondary windings, remote from the two first ends connected together at said intermediate tap; and
an auxiliary synchronous rectifier circuit controlled by a synchronous post regulation control circuit receiving said halfwave second rectified voltage V2 and delivering a halfwave third rectified voltage V3 for said auxiliary outlet.

Thus, although the auxiliary outlet is halfwave rectified, it can achieve voltage values that are equal to or less than the voltage value of the main outlet while using very few electronic components.

Advantageously, said first and second secondary windings are identical and wound in the same direction so as to form a center-tap secondary winding.

Said main automatically controlled synchronous rectified circuit comprises a forward transistor with a grid connected to one end of said second secondary winding and a drain connected to one end of said first secondary winding, and a freewheel transistor having a grid connected to said second end of said first secondary winding and a drain connected to said second end of said second secondary winding, the sources of said forward and freewheel transistors being connected together at a voltage reference point of the main and auxiliary outlets.

Said auxiliary controlled synchronous rectifier circuit comprises a forward transistor having a drain connected to said end of said second secondary winding and a source connected to a drain of a freewheel transistor having a source that is connected to said voltage reference point of the main and auxiliary outlets, the grids of said forward and freewheel transistors being connected to a synchronous post regulation control circuit.

Advantageously, said forward and freewheel transistors are metal oxide on silicon field effect transistors (MOSFETs).

Preferably, said first and third rectified voltages are each filtered by a respective inductance and capacitance (LC) filter to deliver said main and secondary outlet voltages, respectively.

### BRIEF DESCRIPTION OF THE DRAWINGS

The characteristics and advantages of the present invention can be seen better from the following description made by way of non-limiting indication and with reference to the accompanying drawings, in which:

FIG. 1 shows an embodiment of a secondary circuit of a DC/DC converter in accordance with the present invention; and

FIG. 2 is a timing diagram showing various signals measured at certain characteristic points of the FIG. 1 circuit.

### DETAILED DESCRIPTION OF A PREFERRED EMBODIMENT

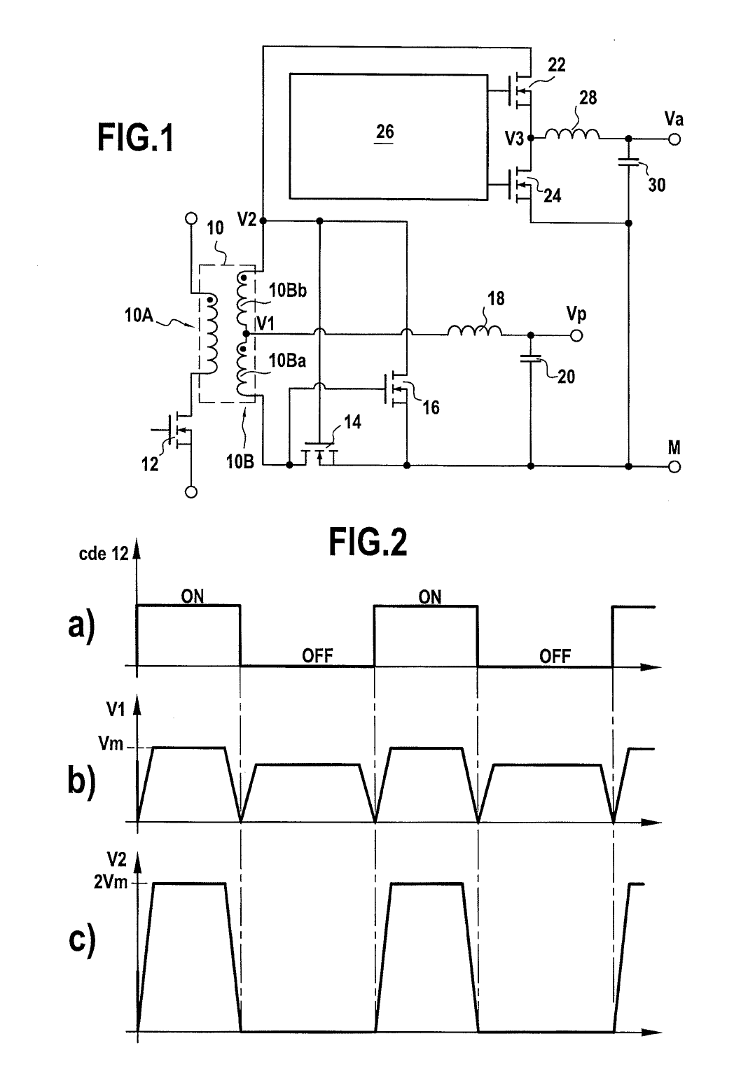

FIG. 1 essentially shows the secondary circuit of a DC/DC converter in accordance with the present invention, comprising a main outlet Vp and an auxiliary outlet Va, the primary circuit of the converter being represented merely by the primary winding 10A of an isolating transformer 10 in series with a control switch 12, advantageously a MOSFET.

In the invention, the secondary winding 10B of the transformer is of the type having an intermediate tap, more precisely a center tap, i.e. it has two identical windings 10Ba and 10Bb that are wound in the same direction and connected in series, such that the voltage across the terminals of each of these two windings is identical. In the description below, the voltage at the intermediate tap (center tap), i.e. at the junction point between the two windings and corresponding to the main outlet voltage prior to filtering is written V1, and the voltage at the inlet point of the second winding 10Bb is written V2.

The main outlet is associated with an automatically-controlled main synchronous rectifier circuit constituted by two switches, advantageously MOSFETs, one of them, 14, acting as a forward transistor, and the other one, 16, acting as a freewheel transistor. The sources of the freewheel transistor 16 and of the forward transistor 14 are connected together at a point M constituting the reference for the main and secondary outlet voltages. The grid of the forward transistor 14 is connected to the drain of the freewheel transistor 16 at the outlet point of the voltage V2 corresponding to one end of the second winding 10Bb that has its other end forming the center tap of the secondary winding of the transformer which is connected to one end of the first winding 10Ba whose other end is connected to the drain of the forward transistor 14 that is connected to the grid of the freewheel transistor 16. These crossed connections at the two ends of the secondary winding of the transformer ensure that the switching of the transistors 14 and 16 is automatically synchronized with the primary circuit.

A conventional LC filter 18 and 20 is connected between the center tap of the transformer secondary delivering the voltage Vi, and the voltage reference point, with the voltage Vp at the main outlet being delivered across the terminals of the capacitor 20 between the voltage reference point M and the outlet from the inductor 18.

The auxiliary outlet is associated with an auxiliary controlled synchronous rectifier circuit constituted by two switches that are advantageously MOSFETs, one of them, 22, acting as a forward transistor, and the other one, 24, as a freewheel transistor, the transistors being controlled by a synchronous post regulation control circuit 26. The forward transistor 22 has its drain connected to the outlet point for the voltage V2 and its source connected to the drain of the freewheel transistor 24 that has its source connected to the voltage reference point. The junction point between the source of the forward transistor 22 and the drain of the freewheel transistor 24 delivers the voltage V3 corresponding to the voltage of the auxiliary outlet prior to filtering.

Like the main outlet, the auxiliary outlet Va is delivered via a conventional LC filter 28 and 30 connected between the source of the forward transistor 22 and the source of the freewheel transistor 24.

The operation of such a circuit is explained below with reference to the timing diagrams of FIG. 2 that show: at a) the control voltage for the control switch 12, at b) the voltage V1, and at c) the voltage V2.

In a first phase, the control transistor 12 of the primary is conductive (ON) and an AC signal is therefore present on the secondary of the transformer 10 causing the forward transistor 14 to conduct and blocking the freewheel transistor 16. This signal is rectified and filtered so as to obtain the desired DC voltage at the main outlet Vp and also, in known manner, so as to obtain the desired auxiliary voltage under the control of the circuit 26. Nevertheless, it is important to observe that the value of the voltage V2 is twice that of the voltage V1 and that the auxiliary rectifier circuit, which is a halfwave rectifier, thus receives this double value and is thus capable of delivering a voltage of value equal to or less than the value of the voltage V1.

In a second phase, the control transistor 12 of the primary is blocked (OFF), thereby blocking the forward transistor 14 and causing the transistor 16 to conduct. The end of the winding 10Bb is zeroed since this point is connected to the voltage reference point through the freewheel transistor 16, so the value of the voltage V2 is therefore zero. At the center tap, the value of the signal V1 is positive, whence the fullwave nature of the main rectifier circuit, with the value of the voltage depending on the duty ratio applied by the transistor 12 (the mean value of V1 during the first phase is equal to the mean value of V1 during the second phase).

By using halfwave rectification on the sum of the two windings (the voltage V2), it is thus possible to double the voltage obtained in order to compensate for the fact of using this type of rectification, and thus obtain an auxiliary outlet of voltage Va that may be equal to the voltage Vp of the main channel. For example, with a main voltage having a value of 3.3 volts (V), it is possible to create an auxiliary channel having a value 2.5 V. Furthermore, this configuration does not involve additional components in order to obtain the halfwave rectified voltage generating the auxiliary voltage Va since it is the transistors that enable the main voltage Vp to be obtained that are reused.

In contrast, if halfwave rectification were used for the voltage V1 to create the auxiliary voltage Va, then the maximum value of this voltage would be limited to half the main voltage Vp, and thus from a main voltage having a value of 3.3 V, it would not be possible to create a 2.5 V auxiliary channel, as is made possible by the invention.

In addition, having recourse to the voltage V2 makes it possible to regulate the auxiliary voltage while avoiding conventional use of a fullwave rectified voltage of stability that is then very difficult to control. Because the amplitude of the rectified voltage during the first phase is generally not equal to the amplitude of the voltage during the second phase (see FIG. 2b), the relationship for controlling regulation of the auxiliary necessarily changes slope. This has the effect of changing the gain of the control when the setpoint goes from one phase to the other so the control needs to be designed to take this sudden change in slope and gain into account, and in practice that is relatively complex. In addition, the zero crossing of the fullwave rectified voltage on switching of the primary transistor gives rise to a fast change in the duty ratio, thereby giving rise to non-linearity or hysteresis in the transfer function for controlling auxiliary regulation, and thus making it even more complicated to control.

What is claimed is:

1. A secondary circuit for a DC/DC converter having a main outlet and an auxiliary outlet, wherein the circuit comprises:
an automatically-controlled main synchronous rectifier circuit receiving a secondary voltage from a transformer having an intermediate tap, having a first secondary winding connected in series with a second secondary winding and delivering a fullwave first rectified voltage for said main outlet at said intermediate tap connecting together two of the ends of said first and second secondary windings, and a halfwave second rectified voltage across the terminals at the other two ends of said first and second secondary windings, remote from the two first ends connected together at said intermediate tap; and
an auxiliary synchronous rectifier circuit controlled by a synchronous post regulation control circuit receiving said halfwave second rectified voltage and delivering a halfwave third rectified voltage for said auxiliary outlet.

2. A DC/DC converter secondary circuit according to claim 1, wherein said first and second secondary windings are identical and wound in the same direction so as to form a center-tap secondary winding.

3. A DC/DC converter secondary circuit according to claim 1, wherein said main automatically controlled synchronous rectified circuit comprises a forward transistor with a grid connected to one end of said second secondary winding and a drain connected to one end of said first secondary winding, and a freewheel transistor having a grid connected to said second end of said first secondary winding and a drain connected to said second end of said second secondary winding, the sources of said forward and freewheel transistors being connected together at a voltage reference point of the main and auxiliary outlets.

4. A DC/DC converter secondary circuit according to claim 1, wherein said auxiliary controlled synchronous rectifier circuit comprises a forward transistor having a drain connected to said end of said second secondary winding and a source connected to a drain of a freewheel transistor having a source that is connected to said voltage reference point of the main and auxiliary outlets, the grids of said forward and freewheel transistors being connected to a synchronous post regulation control circuit.

5. A DC/DC converter secondary circuit according to claim 3, wherein said forward and freewheel transistors are MOSFETs.

6. A DC/DC converter secondary circuit according to claim 1, wherein said first and third rectified voltages are each filtered by a respective LC filter to deliver said main and secondary outlet voltages, respectively.

7. A DC/DC converter including a secondary circuit according to claim 1.
